(19) United States
(12) Patent Application Publication
(10) Pub. No.: US 2006/0208526 A1
(43) Pub. Date: Sep. 21, 2006

(54) Covering system of a truck

(75) Inventors: Robert A. Talbot, Holland, MA (US); Howard A. Greis, Holden, MA (US)

Correspondence Address: YOUNG & BASILE, P.C., 3001 WEST BIG BEAVER ROAD, SUITE 624, TROY, MI, 48084, US

(73) Assignee: Pioneer Consolidated Corp., North Oxford, MA (US)

(21) Appl. No.: 11/083,720

(22) Filed: Mar. 18, 2005

(51) Int. Cl. B60P 7/02

(52) U.S. Cl. 296/100.07

(57) ABSTRACT

An apparatus for opening and closing a cover of a truck is disclosed. The apparatus includes a rotatable shaft that can be connected to multiple supports in order to provide a torsion force to each of the supports to pivotably rotate the supports and the cover between an opened position and a closed position. The shaft is hexagonal in cross-section. The supports are attachable to the cover and are pivotably attached at an end of each support to a side of the container, for supporting the cover and moving the cover between an open position and a closed position. A plurality of hinges are used to pivotably attach the supports to the container and to rotatably receive the shaft proximate to and parallel to the one side of the container. An actuator is used to provide rotary motion to the shaft. The actuator includes a hydraulic cylinder and a chain and sprockets for converting linear motion of the cylinder to rotary motion of the shaft.

### FIELD OF THE INVENTION

The present invention relates to a covering system for covering a cargo area of a truck.

### BACKGROUND OF THE INVENTION

Open top containers associated with a truck or truck trailer are used for hauling loads of material or refuse. Typically, these containers are equipped with a covering system for the open top for covering at least a portion of the open top. The cover can prevent the load of the container from blowing or falling out of the container and/or protect the load from exposure to weather conditions and/or insulate for heat retention in the case of an asphalt load.

In a typical side opening covering system, a cover or tarpaulin is attached to a frame having numerous supports to form a cover assembly. The supports are positioned across the width of the container and are evenly spaced along the length of the container in order to provide support for the cover. The supports which can be bow supports, are usually pivotably attached at one end to a side of the container to allow the cover assembly to move between a covered position and an uncovered position with respect to the open top of the container. Typically, the covering assembly would be moved to a covered position for transit and to an uncovered position for loading and unloading of the container.

Prior covering systems of this type typically open and close the cover assembly by moving a lead support 100 as illustrated in FIG. 12. The lead support 100 is attached to the container, and moving the lead support 100 in turn rotates the cover 102, which includes a structure connecting the remaining supports and a covering material.

Because the forces and torques for opening and closing the cover assembly are exerted through the lead support and not directly on each of the supports, this causes deflection and stress on the cover assembly that can result in reduced longevity.

Thus, it would be desirable to eliminate or minimize deflection and stress on the cover assembly.

### SUMMARY OF THE INVENTION

The present invention provides an apparatus for opening and closing a cover of an open top container of a truck. The apparatus can include a plurality of supports attachable to the cover, means for pivotally attaching an end of each support to one side of the container, and means for moving each of the supports between an opened position and a closed position. The pivotally attaching means can include a plurality of hinges. The moving means can include a shaft and an actuator for providing rotary motion to the shaft. The shaft can be hexagonal in cross-section. The plurality of hinges can be used to pivotably attach the supports to the container and can rotatably receive the shaft proximate to and parallel to the one side of the container.

The actuator can include at least one hydraulic cylinder, which, by example, can be a reversible hydraulic cylinder. A chain is attachable to at least one rod of the hydraulic cylinder and is operably engaged with a sprocket attachable to the shaft in order to translate linear motion of the cylinder to rotary movement of the shaft.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a front perspective view of an open top container of a truck showing an apparatus for covering the top of the container;

FIG. 2 is a side elevational view of the container;

FIG. 3 is a front view of the container showing the apparatus in an opened position with respect to the container;

FIG. 4 is a front view of the container showing the apparatus in an partially opened position with respect to the container;

FIG. 5 is a front view of the container showing the apparatus in an closed position with respect to the container;

FIG. 6 is a simplified partial side elevational view of the apparatus proximate to a front of the container showing a drive shaft;

FIG. 7 is a simplified partial side elevational view of the apparatus proximate to a rear of the container showing the drive shaft;

FIG. 8 is a simplified partial cross sectional view of the apparatus taken generally along line 8-8 of FIG. 6 showing a hinge of the apparatus in the closed position with respect to the container;

FIG. 9 is a simplified partial cross sectional view of the hinge taken generally along line 9-9 of FIG. 6;

FIG. 10 is a simplified partial cross sectional view of a shaft support member of the apparatus taken generally along line 10-10 of FIG. 6;

FIG. 11 is a front view of an actuator of the apparatus; and

FIG. 12 is a front perspective view of a truck showing an example of a prior art cover in a partially opened position with respect to an open top container of the truck.

### DESCRIPTION OF THE PREFERRED EMBODIMENT

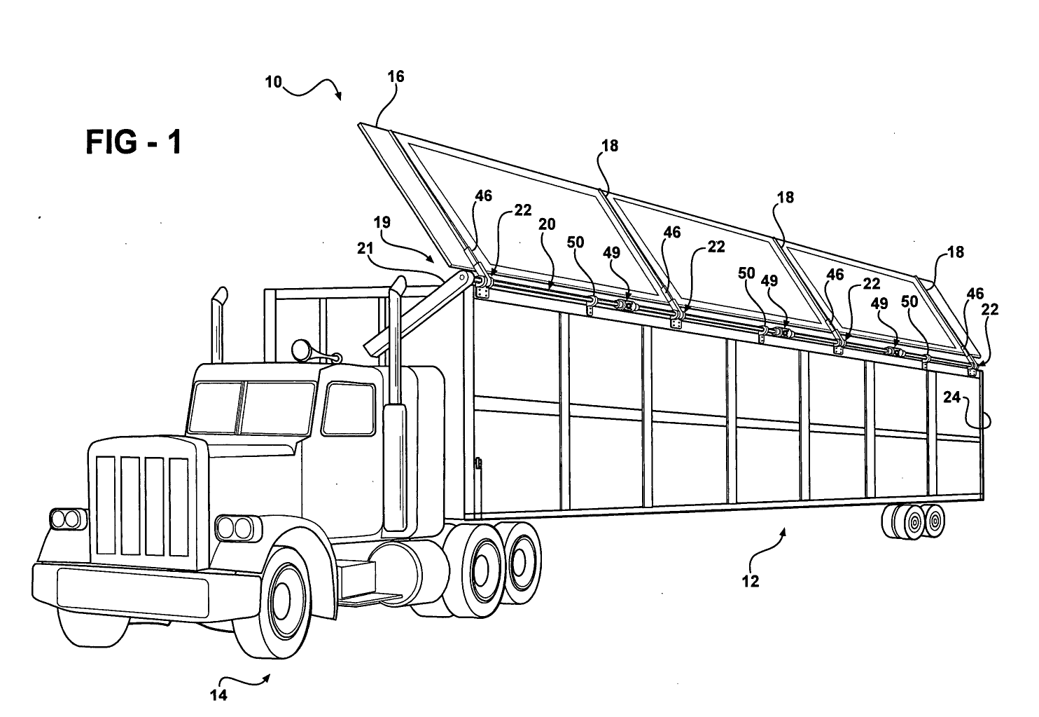

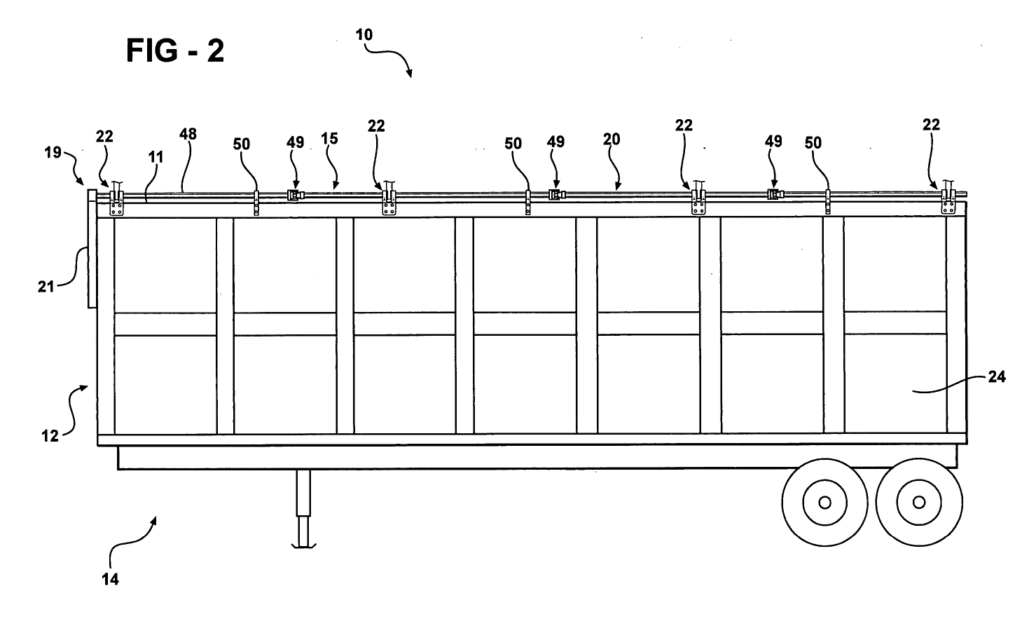

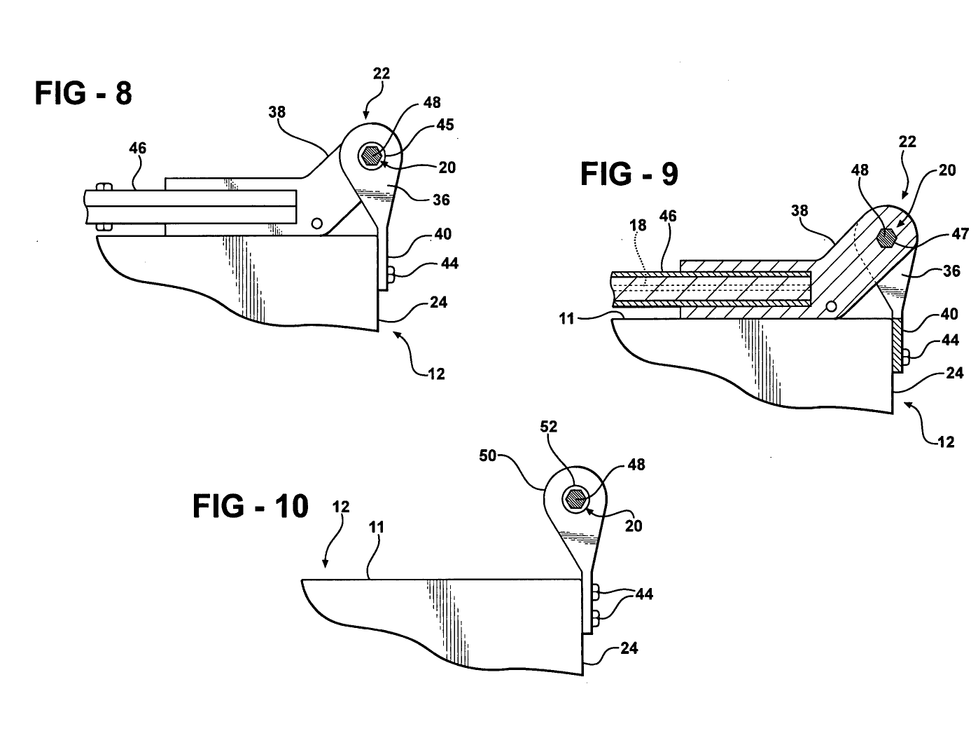

Referring to FIGS. 1-11, an apparatus 10 for covering a top 11 of a container 12 of a truck or truck trailer 14 is disclosed. A cover 16 can be attached to a plurality of cover supports 18. By way of example and not limitation, the cover 16 can be a tarpaulin material and/or a mesh material. The supports 18 are moved between an opened position and a closed position with respect to the container 12 by moving means 19, which can include a shaft 20 and an actuator 21. The shaft 20 provides an equal force to each support 18 in order to rotatably move the supports 18 and the cover 16 between an opened position and a closed position with respect to the container 12. The shaft 20 can be, for example, round, rectangular, polygonal, and/or hexagonal in cross section as shown in FIGS. 8-10.

As seen in FIGS. 1-2 and 6-9, means for pivotally attaching the supports 18 to the container 12 can include a plurality of hinges 22, each for pivotally attaching one support 18 to a side 24 or top 11 of the container 12. The supports 18, the shaft 20, and the hinges 22 can be formed of a metal material such as steel. The metal material can be a coated material to prevent corrosion.

Referring to FIGS. 8 and 9, a detailed view of one hinge 22 is shown. The hinge 22 can include a fixed member 36 that can be attached to the side 24 or top of the container 12 and a movable member 38 attached to respective supports 18.

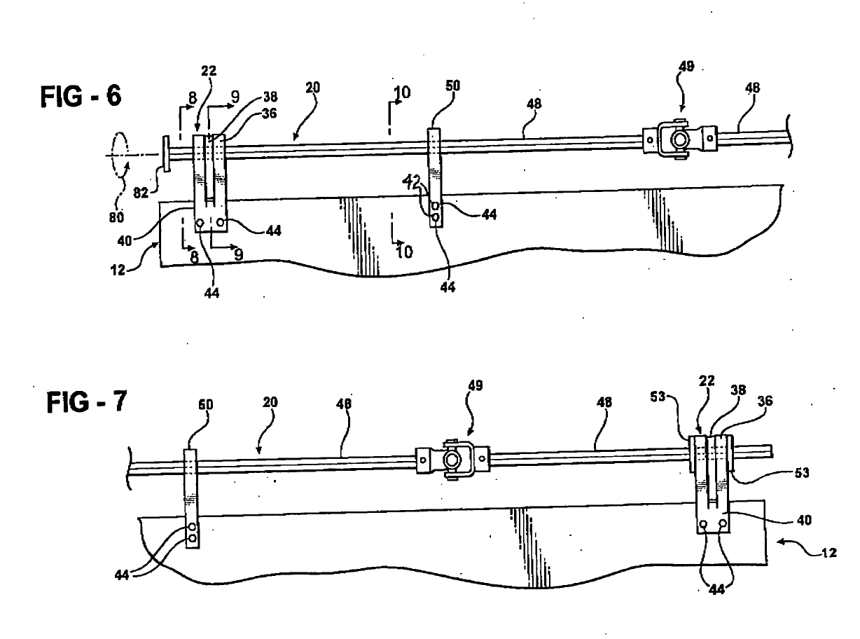

As best seen in FIGS. 6-9, the fixed member 36 shown which includes a mounting bracket 40, which can be integrally formed with the fixed member 36 and can include at least one aperture 42 for each receiving a fastener 44 for attaching the fixed member 36 to the side 24 of the container 12. The mounting bracket 40 can be generally rectangular in shape, for example. The fastener 44 can be a bolt and/or a screw. The fixed member 36 can additionally or alternately be attached to the container 12 by welding or any such suitable means as are known in the industry. Each fixed member 36 can include at least one shaft bearing or bushing 45 for rotatably receiving the shaft 20 to allow rotation of the shaft 20 with respect to the fixed member 36.

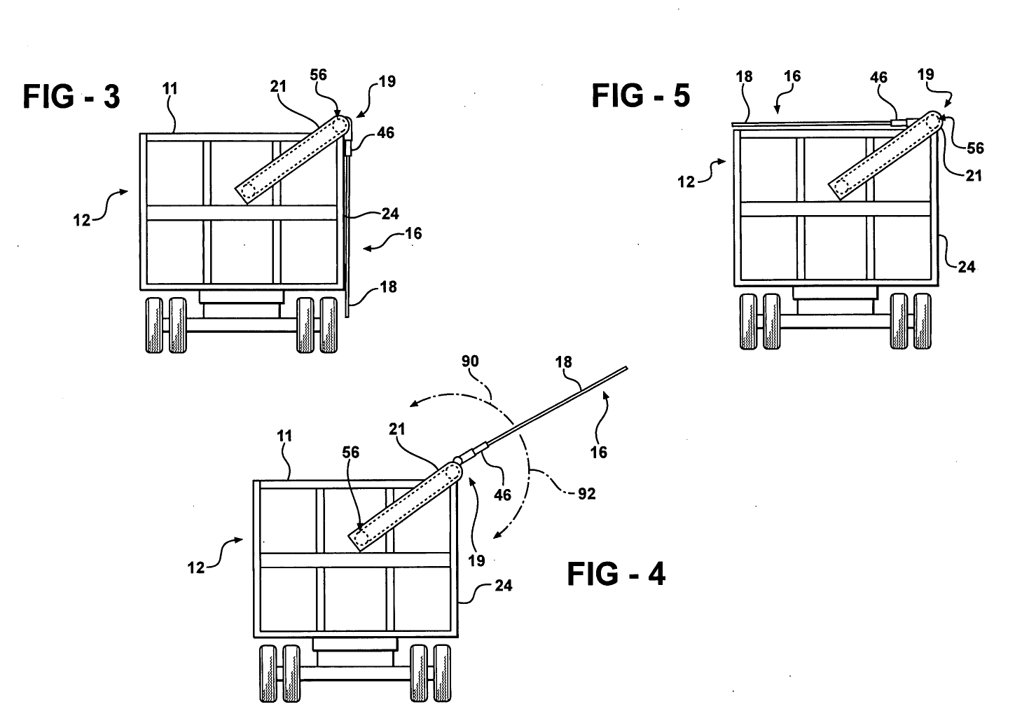

The movable member 38 includes a connector, which can include a sleeve 46 for connecting each support 18 to each movable member 38 as shown in FIGS. 1, 3-5, and 8-9. The shaft 20 is fixedly attached to each movable member 38 and is rotatably received by each fixed member 36. According to one way of fixing the shaft 20 to the movable member 38, the movable member 38 has a shaft aperture 47 with a complementary shape to the shaft 20 in order to fix the shaft 20 with respect to the movable member 38. As the shaft 20 rotates, each movable member 38 rotates with respect to the container 12, and thus each support 18 rotates. Rotation of the shaft 20 thus causes the supports 18 to rotate with respect to the container 12 between a closed position as shown in FIG. 3, a partially opened position as shown in FIG. 4, and an opened position as shown in FIG. 5.

As seen in FIGS. 1-2 and 6-7, the shaft 20 can include multiple shaft lengths 48 attachable end to end by shaft connectors 49, which are shown but not limited to, yoke-type connectors. Optionally, multiple shaft support members 50 provide support to the shaft 20 and are spaced between the hinges 22. Each support member 50 can include at least one support bearing or bushing 52 (shown in FIG. 10) for rotatably receiving the shaft 20 to allow rotation of the shaft 20 with respect to the support member 50. Each support member 50 can be attached to the container 12 using at least one fastener 44 or any such suitable means as are known in the industry. Preferably, at least one pair of retainers 53 are mounted on respective sides of each hinge 22 and optionally, each support member 50 to prevent linear movement of the shaft 20 relative to the container 12. The retainers 53 can be generally disk-like in shape and each retainer 53 in each pair is attached to the shaft 20 on an opposite side of one hinge 22 relative to another retainer 53 in the pair.

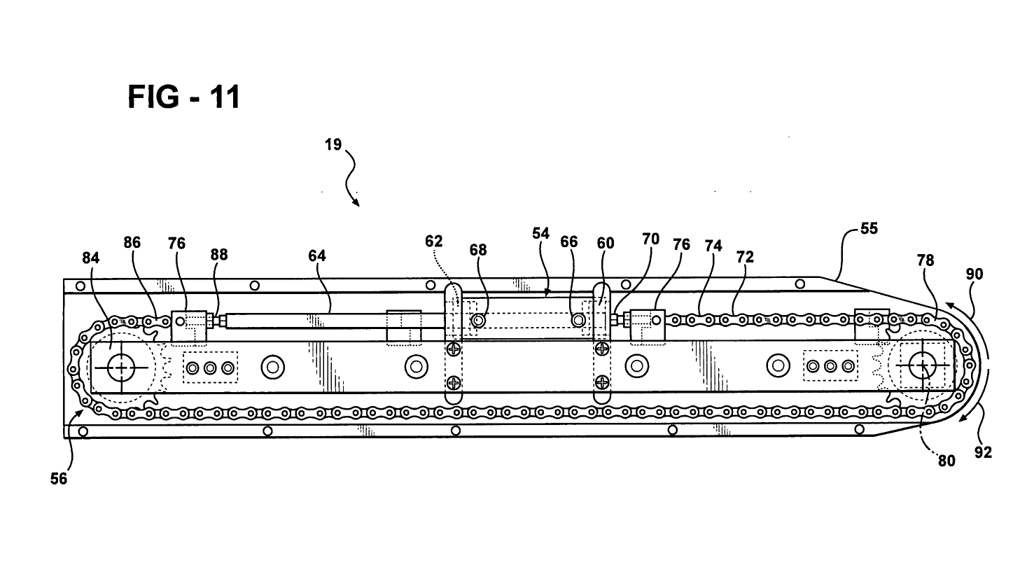

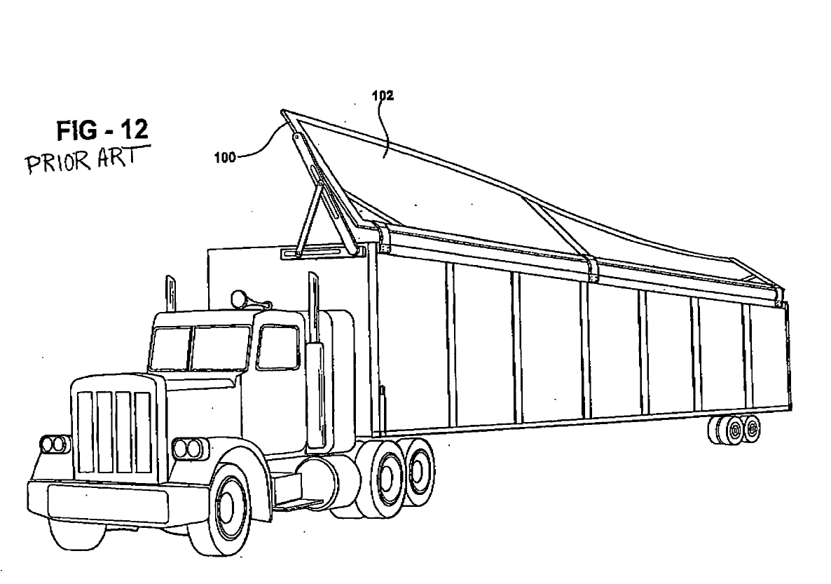

Referring now to FIGS. 1-5 and 11, the moving means 19 includes the shaft 20 and the actuator 21. The actuator 21 shown includes an air or a hydraulic cylinder 54, a housing 55, and translation means 56, shown in phantom in FIGS. 3-5, for translating linear movement of the hydraulic cylinder 54 into rotary movement of the shaft 20 as shown in FIG. 11. The hydraulic cylinder 54 can be a reversible cylinder, which includes a first piston 60 and a second piston 62 connectible to a rod 64. The cylinder 54 can include a first port 66 and a second port 68 associated with the first piston 60 and the second piston 62, respectively. The rod 64 is attachable at a first rod end 70 to a chain 72 at a first chain end 74. A chain connector 76 attaches the first rod end 70 to the first chain end 74. The chain 72 operably engages a first sprocket 78 proximate to the first chain end 74. The first sprocket 78 is attached to the shaft 20 and is positioned coaxially to an axis of the rotation 80 of the shaft 20. Preferably, the first sprocket 78 is connected to a flange 82 (shown in FIG. 6) associated with the shaft 20. The chain 72 then extends from the first sprocket 78 to operably engage a second sprocket 84. The chain 72 is connected at a second chain end 86 to a second rod end 88. The second chain end 86 is shown attached to the second rod end 88 using another connector 76.

In operation, fluid or compressed air enters the cylinder 54 through the first port 66 thereby exerting a force on the first piston 60 and causing the first piston 60, the rod 64 and accordingly, the chain 72 to move linearly in a direction away from the first sprocket 78. In turn, the chain 72 operably engages the first sprocket 78 and causes the first sprocket 78 and the attached shaft 20 to rotatably move in a closed direction 90, thereby causing the supports 18 and the cover 16 to move in the closed direction 90 as shown in FIGS. 4 and 5. Alternately, the fluid or compressed air can enter the second port 68 causing the second piston 62 and the rod 64 to move in a direction towards the first sprocket 78 and thus causing the rod 64 and chain 72 to move in that direction. The chain 72 operably engages the first sprocket 78 and thus causes the first sprocket 78 to rotatably move the shaft 20 in an opened direction 92, thereby causing the supports 18 and the cover 16 to move in the opened direction 92 as shown in FIGS. 3 and 4.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. An apparatus for opening and closing a cover of a container, mounted on a truck, the apparatus comprising:
a plurality of supports attachable to the cover;
means for pivotably attaching an end of each support directly to the container; and
means for moving each of the supports between an opened position and a closed position.

2. (canceled)

3. The apparatus of claim 1, wherein the pivotably attaching means further comprises a plurality of hinges.

4. The apparatus of claim 3, wherein each of the plurality of hinges further comprises:
a fixed member attached to the container; and
a movable member attached to an end of a respective support and to the moving means.

5. The apparatus of claim 4, wherein the fixed member further comprises at least one bushing for rotatably receiving the moving means.

6. The apparatus of claim 4, wherein the fixed member further comprises at least one aperture for receiving means for attaching the fixed member to the container.

7. The apparatus of claim 6, wherein the attaching means further comprises at least one fastener.

8. The apparatus of claim 4, wherein the movable member further comprises a connector attaching the end of the respective support to the movable member.

9. The apparatus of claim 1, wherein the moving means further comprises:
a shaft attached to each support and fixedly mounted parallel to and above a top edge of the of the container; and
an actuator for providing rotary motion to the shaft such that the shaft rotates about its own axis.

10. The apparatus of claim 9, wherein the shaft has a hexagonal shape when viewed in a cross section perpendicular to a longitudinal axis of the shaft.

11. The apparatus of claim 9, wherein the shaft further comprises:
a plurality of shaft lengths;
at least one shaft support member for supporting the shaft relative to the container; and
means for connecting the plurality of shaft lengths end to end.

12. The apparatus of claim 11, wherein the connecting means further comprises at least one yoke connector.

13. The apparatus of claim 9, wherein the actuator further comprises:
at least one hydraulic cylinder for providing linear motion; and
means for translating linear motion of the at least one hydraulic cylinder into rotary movement of the shaft.

14. The apparatus of claim 13 wherein the at least one hydraulic cylinder further comprises a reversible hydraulic cylinder.

15. The apparatus of claim 13, wherein the translation means further comprises:
at least one rod attachable to the at least one hydraulic cylinder;
a chain attachable to the at least one rod; and
at least one sprocket operably engaged with the chain where the at least one sprocket is attachable to the shaft.

16. The apparatus of claim 15, wherein the at least one rod, the chain, and the at least one sprocket are positioned co-planar with respect to each other.

17. An apparatus for opening and closing a cover for an open top container associated with a truck or truck trailer, the cover having a plurality of supports to support a covering material, the apparatus comprising:
a rotatable shaft connected to an end of each of the supports and is configured to provide a torsion force to each of the supports to move the cover between an opened position and a closed position;
a plurality of hinges pivotably attaching respective ones of the supports to the container and fixedly mounting the shaft proximate to and parallel to a side of the container; and
an actuator for rotatably moving the shaft.

18. The apparatus of claim 17, wherein the shaft further comprises a hexagon when viewed in a cross section perpendicular to a longitudinal axis of the shaft.

19. The apparatus of claim 17, wherein the actuator further comprises:
at least one hydraulic cylinder for providing linear motion; and
means for translating linear motion of the at least one hydraulic cylinder into rotary movement of the shaft.

20. The apparatus of claim 19, wherein the translation means further comprises:
at least one rod attachable to the at least one hydraulic cylinder;
a chain attachable to the at least one rod;
a first sprocket operably engaged with the chain and attachable to the shaft; and
a second sprocket operably engaged with the chain.

21. The apparatus of claim 19 wherein the torsion force is an equal torsion force.
